(19) United States
(12) Patent Application Publication
(10) Pub. No.: US 2026/0091562 A1
(43) Pub. Date: Apr. 2, 2026

(54) PROCESS FOR PRODUCING A COMPOSITE COMPONENT COMPRISING AT LEAST ONE METAL LAYER AND ONE POLYMER LAYER

(71) Applicants: BASF SE, Ludwigshafen am Rhein (DE); Chemetall GmbH, Frankfurt am Main (DE)

(72) Inventors: Andreas RADTKE, Ludwigshafen am Rhein (DE); Patrick SPIES, Ludwigshafen am Rhein (DE); Nawel Souad KHELFALLAH, Frankfurt am Main (DE); Gerrit SCHUELLERMANN, Frankfurt am Main (DE)

(21) Appl. No.: 19/113,620

(22) PCT Filed: Sep. 22, 2023
(86) PCT No.: PCT/EP2023/076257

§ 371 Date: Mar. 20, 2025

(30) Foreign Application Priority Data
Sep. 23, 2022 (EP) 22197437.1

(51) Int. Cl. B29C 65/00; B29C 65/14; B29C 65/44; B29L 9/00; B32B 15/08

(52) U.S. Cl. CPC B29C 66/742; B29C 65/1412; B29C 65/44; B29C 66/026; B29C 66/45; B29C 66/82661; B32B 15/08; B29L 2009/003; B32B 2255/06; B32B 2255/26

(57) ABSTRACT

The invention relates to a process for producing a composite component comprising at least one metal layer and one polymer layer, the process comprising: (a) heating a metal sheet which optionally comprises a surface treatment; (b) placing a polymer film on the metal sheet and optionally heating the polymer film; (c) applying a vacuum to contact the polymer film with the entire surface of the metal sheet and to remove air enclosed between the metal sheet and the polymer film; (d) optionally holding the temperature of the metal sheet and the polymer film above a temperature at which the connection of the polymer film and the metal sheet is promoted to achieve the composite component.

The invention relates to a process for producing a composite component comprising at least one metal layer and one polymer layer.

Such laminates can be used for example in automotive engineering and electromobility for producing seating structures, underbody elements or battery housings or in electronic housings. The laminate further may be used for an electromagnetic shielding, as a diffusion barrier, for instance against oil, fuel or cooling media.

The production of integral structures comprising a metal and a polymer is described for example in WO-A 02/068257. Here, fastening means are used to secure the plastic to the metal or the metal is joined with injection molded polymer.

A plate shaped or ribbon-shaped semi-finished product and a method for producing such a semi-finished product is described in WO-A 2016/083083. The semi-finished product comprises at least one metal layer and at least one plastic layer, which are connected over the entire surface to form a composite. The composite is formed by a coil coating process.

A further process for producing composite components comprising at least one metal and at least one polymer is known from WO-A 2021/063011. For producing the composite component, a metal component being coated with an adhesion promoter or a primer is brought into contact with a polymeric component. The metal component and the polymeric component are then joined by a physical treatment like laser transmission welding, ultrasonic welding, friction welding and/or thermal melt joining.

However, each of the known processes either needs a complex machinery and a large number of process steps for producing a composite component which comprises a metal layer and a polymer layer or is used for connecting functional elements to the metal but not coating the metal with a polymer layer.

Thus, it was an object of the present invention to provide a process for producing a composite component comprising at least one metal layer and one polymer layer which can be carried out without complex machinery and a large number of process steps and which further allows the production of a composite component being coated with a polymer.

This object is achieved by a process for producing a composite component comprising at least one metal layer and one polymer layer, the process comprising:
(a) heating a metal sheet which optionally comprises a surface treatment;
(b) placing a polymer film on the metal sheet and optionally heating the polymer film;
(c) applying a vacuum to contact the polymer film with the entire surface of the metal sheet and to remove air enclosed between the metal sheet and the polymer film;
(d) optionally holding the temperature of the metal sheet and the polymer film above a temperature at which the connection of the polymer film and the metal sheet is promoted.

This process allows for applying a polymer layer on the entire surface of a metal sheet with less effort than a coil coating process where the metal sheet and the polymer are guided through a large number of rollers. Further, by this process also smaller metal sheets may be coated with a polymer layer. It is not necessary to coat a whole coil.

For achieving a stable connection of the metal sheet and the polymer film, it is preferred that the metal sheet comprises a surface treatment at least on that surfaces on which the polymer film is applied. The surface treatment particularly is an adhesion promoter or a primer to improve the connection of the polymer film and the metal sheet.

The adhesion promoter or primer preferably is based on polyacrylic acid, polymethacrylic acid, polyacrylates or polymethacrylates, polyvinyl amines, phosphoric acids, polyphosphoric acid, vinyl phosphonic acid copolymers, copolymers of maleic acid and at least one of acrylic acid, methacrylic acids and esters of acrylic or methacrylic acid, copolymers of maleic acid and styrene, copolymers of ethylene and maleic acid, copolymers of ethylene, polyvinylpyrrolidone and at least one of acrylic acid, methacrylic acids, esters of acrylic acid or methacrylic acid and maleic acid, and modified polyvinyl(phenol) Usually, the adhesion promoter or primer is applied as an aqueous solution combined with inorganic components such as H₂TiF₆, organosilanes, zinc oxide by a coating process like roll coating. The application of the adhesion promoter is not limited to roll coating, it can also be applied by brushing, dipping or spraying.

The metal of the metal sheet may be for instance an aluminum alloy, steel, a magnesium alloy, copper or galvanized steel like zinc-coated steel. If the metal sheet is made of steel, the steel may be galvanized by hot-dip galvanization or electro galvanization. The thickness of the metal sheet preferably is in a range from 0.01 to 3.0 mm, more preferred in a range between 0.1 to 2 mm and particularly in a range between 0.5 and 2.0 mm. Particularly preferably, the metal of the metal sheet is a galvanized steel type, for example a hot dip galvanized steel or a zinc-alu-minum-magnesium alloy (ZM).

The polymer film preferably is made of a thermoplastic material. Using a thermoplastic material has the advantage that by heating the material is ductile and can be adapted to the form of the metal sheet. Further, a thermoplastic material can melt without decomposition and thus is weldable, by which a good connection with the metal sheet can be achieved. The thermoplastic material preferably is selected from thermoplastic polyurethane, polybutylene terephthalate, polycarbonate, and polyamide and further may contain additives. Preferably, the thermoplastic material is selected from PA6, PA66, PA66/6, PA6.10, PA6.12, PA12, PA9T, PA61/6T, PA6T/6I, PA6/6.36 or combinations thereof. Particularly preferably, the thermoplastic material comprises a polyether block polyamide such as copolymerisates of polyether diamines and aliphatic C₄ to C₄₀ dicarboxylic acids and/or C₆ to C₁₂ lactams like caprolactam or lauryllactam, copolymerisates of aliphatic C₄ to C₁₀ diamines and aliphatic C₄ to C₄₀ dicarboxylic acids, polycondensates of C₆ to C₁₂ lactams, copolymerisates of lactams and/or aliphatic dicarboxylic acids and aliphatic diamines or combinations thereof.

The thermoplastic polymer may contain further additives such as glass fibers, carbon fibers, ar-amid fibers or combinations thereof. These fibers can be incorporated as roving or cuttings in the usual commercial form. Furthermore, woven fabrics, scrims, flow mats and staple fibers made of the above-mentioned reinforcing materials can also be used.

Further, the thermoplastic material may also contain impact modifiers like maleic anhydride grafted copolymers of ethylene and at least one of a-olefins, acrylic acid esters, and acrylic acid, copolymers of maleic anhydride and at least one of ethylene and acrylic acid esters, styrene maleic anhydride or maleic anhydride grafted polypropylene.

Further additives, the thermoplastic material may contain are any additives usually used in thermoplastic materials like plasticizers, flame retardants, dyes or UV-stabilizers.

For connecting the metal sheet and the polymer layer, in a first step (a), the metal sheet is heated.

Heating of the metal sheet may be carried out by any heating method known to the skilled person. The metal sheet may be heated for example by inductive heating or near infrared radiation or by using an oven which may be operated electrically or which may be heated with a fuel. Further, if the metal sheet is a plane metal sheet, it is further possible to heat the metal sheet by direct heating, for example by passing the metal sheet between two heated rollers. However, preferably, the metal sheet is heated in an electrically operated oven or by inductive heating.

To achieve a stable connection, the metal sheet is heated to a temperature at which the connection of the thermoplastic material with the metal sheet, particularly the chemical reaction of the thermoplastic material with the surface treatment, is promoted. For this purpose, the metal sheet may be heated to a temperature above the melting temperature of the thermoplastic material. However, if the reaction of the thermoplastic material and the metal sheet is promoted at lower temperatures, even a lower temperature may be sufficient. A suitable temperature to which the metal sheet may be heated is a temperature in the range from 150° C. to 250° C., preferably 170° C. to 220° C., e.g. in case of polyamide based films.

After heating the metal sheet, the metal sheet is placed into a device in which the polymer film can be placed on the metal sheet, preferably a thermoforming device. As an alternative, it is also possible to firstly place the metal sheet into the device in which the polymer film can be placed on the metal sheet and then heat the metal sheet before placing the polymer film on it.

After the heated metal sheet is placed in the device or after the metal sheet is placed in the device and then heated, the polymer film is placed on the metal sheet and optionally heated. If the polymer film is heated, heating of the polymer film preferably is for example carried out by infra-red radiation. However, any other contactless heating method by which the polymer film can be heated after being placed on the metal sheet can be used.

The temperature to which the polymer film is heated preferably is selected such that the thermoplastic material is rubbery elastic. For this purpose, the thermoplastic material preferably is heated to a temperature above the glass transition temperature of the thermoplastic material, if the thermoplastic material is an amorphous thermoplast, or above the crystallite melting temperature, if the thermoplastic material is a semi-crystalline thermoplast, but preferably below the melting temperature to avoid a damage of the polymer film.

After placing the polymer film on the metal sheet and optionally heating the polymer film, a vacuum is applied to contact the polymer film with the entire surface of the metal sheet and to remove air enclosed between the metal sheet and the polymer film.

By applying the vacuum, the polymer film is attached to the surface of the metal sheet and a strong connection can be achieved. Removing the air which may be enclosed between the metal sheet and the polymer film results in a smooth surface without blisters.

For applying the vacuum, the metal sheet may comprise openings through which air can be withdrawn. If the metal sheet should not have any openings, it is also possible to withdraw the air between the metal sheet and the polymer film at the edges of the polymer film. If the air is withdrawn at the edges of the polymer film, it is preferred to withdraw the air at least at two opposite sides and preferably over the whole circumference of the polymer film.

For applying the vacuum, any suitable vacuum pump can be used. If the metal sheet comprises openings for withdrawing the air between the metal sheet and the polymer film, the vacuum pump is connected to a space below the metal sheet. Particularly if the metal sheet comprises more than one opening, by the space can be ensured that the pressure is the same at all openings and the polymer film is attracted uniformly to the metal sheet. If the metal sheet comprises only one opening for applying the vacuum, the vacuum pump may be connected directly to that opening.

If the air is withdrawn at the edges of the polymer film, the polymer film is fixed such in a device for applying the vacuum, that a gap is formed between the metal sheet and the edge of the polymer film and the vacuum is applied through that gap.

By applying the vacuum, the polymer film contacts the metal sheet uniformly over its entire surface and, thus, a uniform polymer layer is formed on the metal sheet.

After contacting the polymer film with the entire surface of the metal sheet, the temperature of the metal sheet and the polymer film is held at the temperature at which the connection of the thermoplastic material and the metal sheet is promoted, preferably at a temperature above the melting temperature of the thermoplastic material of the polymer film. By holding the temperature, the thermoplastic material reacts chemically with the adhesion promoter or primer by which a stable connection of the metal sheet and the polymer film is achieved and the composite component comprising a metal layer and a polymer layer is formed.

Depending on the thickness of the metal sheet, the time which is needed for the metal sheet to cool to a temperature below the melting temperature of the thermoplastic material is sufficient for achieving a stable connection of the metal sheet and the polymer film. Preferably, the temperature of the metal sheet and the polymer film is hold above the melting temperature of the thermoplastic polymer for 1 to 120 s, more preferred 1 to 60 s and particularly 5 to 30 s.

If the time the metal sheet needs for cooling to a temperature below the melting temperature of the thermoplastic material is not sufficient for a stable connection of the polymer film to the metal sheet, it may be necessary to heat the metal sheet for holding the temperature. Besides heating, it also may be sufficient to place the metal sheet on a thermally insulating material before applying the polymer film on the metal sheet as due to the insulating material, heat particularly is dissipated on that side of the metal sheet onto which the polymer film is applied.

The composite component produced by the inventive process may be a semi-finished product or a finished formed component. If the composite component is a semi-finished product, the composite component may be a flat sheet or a preformed component. Independently of whether the composite component is a flat sheet or a preformed component, for finishing the component the composite component may be further shaped, for example by a deep-draw process.

Also other geometries, where a film can be draped on are possible. The inventive process is not restricted to sheet-like geometries (like a coil coated product would be). E.g. thicker cable-like structures like busbars can be coated with a film or leadframes.

As an alternative or in addition to the further shaping of the composite component, it is possible to apply functional elements made of a polymeric material to the composite component. Such functional elements may be for example stiffening elements, fixing elements for fixing another component to the composite component, for example clips or threads into which a screw may be inserted. Further, the functional elements also may be design elements which are applied on the composite component.

The functional elements may be applied to the composite component by any suitable process known to the skilled person, for example by gluing or welding. Particularly, the functional elements are applied to the composite component by welding.

If the functional elements are applied to the composite component by welding, any welding process for welding two polymer parts can be used. Suitable welding processes applying the functional element to the polymer layer of the composite component for example are laser welding, ultrasonic welding, friction welding or thermal melt joining.

Besides applying functional elements by gluing or welding, it is also possible to directly form the functional elements on the polymer layer of the composite component. In this case, the functional elements preferably are formed by injection molding. For forming the functional elements, the composite component is inserted into an injection mold, the mold is closed and subsequently a polymer melt is injected into the mold for forming the functional element.

If the semi-finished product or the finished formed component has a shape different to a plane sheet, it is preferred to preform the metal sheet and to apply the polymer film onto the pre-formed metal sheet. For preforming the metal sheet any process for forming a metal sheet can be used, for example deep drawing or pressing.

Independently of whether the metal sheet is preformed or a plane metal sheet is used for producing the composite component, it is preferred to place the metal sheet into a mold before placing the polymer film on the metal sheet.

Due to the application of a vacuum for contacting the polymer film with the entire surface of the metal sheet, the polymer film is drawn into each position on the surface of the metal sheet and the polymer film forms a uniform and complete contact with the metal sheet.

Besides preforming the metal sheet before placing it into the device for applying the polymer film for producing a preformed semi-finished article or a finished formed component, it is also possible to use only one device, in which the metal sheet is formed and the polymer film is applied on the metal sheet.

In this case, a plane metal sheet is inserted into a mold in the device and subsequently formed for example by a deep drawing process or a pressing process. After the metal sheet is formed into the desired shape, the metal sheet is heated and then the polymer film is placed on the heated metal sheet. Subsequently the vacuum is applied to contact the polymer film with the entire surface of the metal sheet to produce a shaped composite component.

By the inventive process, the composite component can be produced without using a complex process for producing laminates. Particularly, it is not necessary to provide a mold having a matrix and a patrix for producing the composite component. As in the inventive process for applying the polymer film on the metal sheet the polymer film is not in contact with a mold, it is not necessary to completely cool the composite component before removing from the mold and, thus, the production capacity may be increased.

1.-12. (canceled)

13. A process for producing a composite component comprising at least one metal layer and one polymer layer, the process comprising:
(a) heating a metal sheet which optionally comprises a surface treatment;
(b) placing a polymer film on the metal sheet and optionally heating the polymer film;
(c) applying a vacuum to contact the polymer film with the entire surface of the metal sheet and to remove air enclosed between the metal sheet and the polymer film; and
(d) optionally holding the temperature of the metal sheet and the polymer film above a temperature at which the connection of the polymer film and the metal sheet is promoted to achieve the composite component;
wherein the polymer film is made of a thermoplastic material and wherein the metal sheet is heated to a temperature at which the connection of the thermoplastic material and the metal sheet is promoted before the polymer film is placed on the metal sheet.

14. The process according to claim 13, wherein the polymer film is heated by infrared radiation.

15. The process according to claim 13, wherein the metal sheet is preformed.

16. The process according to claim 13, wherein the metal sheet is placed in a mold before placing the polymer film on the metal sheet.

17. The process according to claim 13, wherein the metal is steel, galvanized steel, an aluminum alloy, a magnesium alloy or copper.

18. The process according to claim 13, wherein the surface treatment comprises an adhesion promoter or primer.

19. The process according to claim 18, wherein the adhesion promoter or primer comprises polyacrylic acid, polymethacrylic acid, polyacrylates or polymethacrylates, polyvinyl amines, vinyl phosphonic acid copolymers, phosphoric acids, polyphosphoric acid, copolymers of maleic acid and at least one of acrylic acid, methacrylic acids and esters of acrylic or methacrylic acid, copolymers of maleic acid and styrene, copolymers of maleic acid and ethylene, copolymers of ethylene, polyvinylpyrrolidone and at least one of acrylic acid, methacrylic acids, esters of acrylic acid or methacrylic acid and maleic acid and modified polyvinyl(phenol).

20. The process according to claim 13, wherein the thermoplastic material is selected from thermoplastic polyurethane, polybutylene terephthalate, polycarbonate and polyamide and further may contain additives.

21. The process according to claim 13, wherein the temperature to which the metal sheet is heated is above the melting temperature of the thermoplastic material.

22. The process according to claim 13, wherein functional elements made of a polymeric material are applied to the polymer layer.
